(19) United States
(12) Patent Application Publication
(10) Pub. No.: US 2004/0103414 A1
(43) Pub. Date: May 27, 2004

(54) Method and apparatus for interprocess communications

(76) Inventors: David M. VomLehn, Austin, TX (US); Jerry A. Bolton JR., Round Rock, TX (US)

Correspondence Address: HEWLETT-PACKARD COMPANY, Intellectual Property Administration, P. O. Box 272400, Fort Collins, CO, 80527-2400, US

(21) Appl. No.: 10/306,126

(22) Filed: Nov. 27, 2002

(51) Int. Cl. G06F 9/46; G06F 9/00

(52) U.S. Cl. 718/102

(57) ABSTRACT

A method and apparatus is described that may allow a plurality of processes to communicate status or other information. The processes may, in some embodiments, utilize a shared memory location to determine the availability of the shared resource. Additionally, in some embodiments, a process waiting for a shared resource may wait for a condition precedent to occur before continuing execution or, in some embodiments, the process may perform other tasks while waiting for a memory location to contain a set of one or more predetermined values.

### BACKGROUND

In computer systems that support multithreaded operating systems, there may exist a need to provide inter-thread status communications. This may be particularly true in situations where limited computational or other resources are in contention. That is, more than one thread, or process, may need to utilize the same resource to perform one or more functions.

While there are many limited resources within a computer or computing environment, typical resources may include a printer, a network communications device, a storage device, or other system or interconnected resource.

The present invention may address one or more of the problems set forth above.

### BRIEF DESCRIPTION OF THE DRAWINGS

The invention may be best understood by referring to the following description and accompanying drawings that are used to illustrate embodiments of the invention.

FIG. 1 illustrates a computer system in accordance with embodiments of the present invention;

FIG. 2 illustrates a flow chart of an inter-process communications method in accordance with embodiments of the present invention;

FIG. 3 illustrates an operating system function in accordance with embodiments of the present invention; and

FIG. 4 illustrates a flow chart of a operating system process in accordance with embodiments of the present invention.

### DETAILED DESCRIPTION

In the following description, numerous specific details are set forth to provide a detailed understanding of the present invention. However, one skilled in the art will readily appreciate that the present invention may be practiced without these specific details. For example, the described code segments are provided by way of example and not by way of limitation, as other programming structures may be similarly utilized.

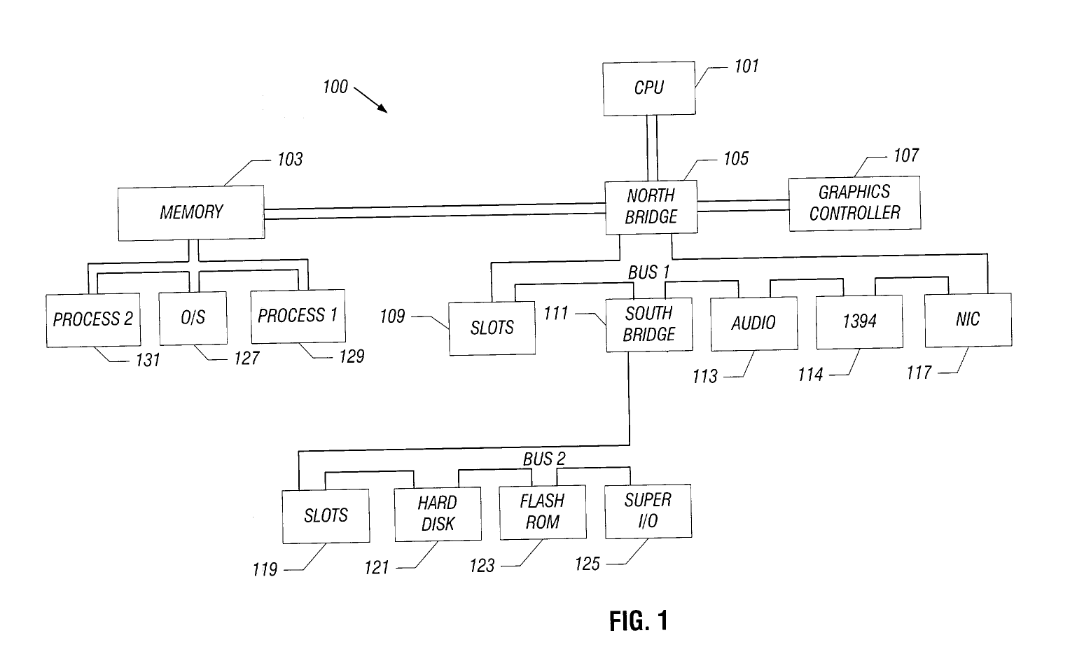

Referring now to FIG. 1, a computer system 100 may include a central processing unit 101, one or more memory devices 103, and a bridge device such as a north bridge 105.

The north bridge 105 may be coupled to a graphics controller 107 that may, in some embodiments, be connected to the north bridge 105 through an advanced graphics processor (AGP) bus.

Additionally, north bridge 105 may be coupled through bus 1 to plug in slots 109 that may be utilized, in some embodiments, to expand the computer resources. Additionally, north bridge 105 may be coupled through bus 1 to a second bridge device such as south bridge 111. North bridge 105 may also be coupled through bus 1 to various peripheral devices such as audio section 113, an IEEE 1394 interface device 114, and a network interface card (NIC) 117.

South bridge 111, may be coupled through bus 2 to devices such as expansion slots 119. In addition, south bridge 111 may be coupled to storage devices such as a hard disk 121 and a Read Only Memory (“ROM”) device such as, in some embodiments, a Flash ROM. Additionally, in some embodiments, the south bridge 111 may also be coupled to a super I/O controller 125.

Bus 1 and bus 2 may be implemented in any suitable bus architecture. For example, a peripheral connect interface bus (PCI) or other interface bus.

Memory 103 may contain code such as operating system 127, which may be utilized by CPU 101 or other CPU to control one or more functions of the computer system 100. Additionally, operating system 127 may directly or indirectly interface with one or more processes such as process 1, 129, and process 2, 131. These processes may each be a thread that may run concurrently or sequentially on the computer system 100. Additionally, these processes 129 and 131 may each utilize one or more of the resources of the computer system 100. For example, process 1 and process 2 may both interface with the network interface controller circuit 117. However, if both processes use the network interface circuitry 117 at the same time, results will generally be unpredictable and, therefore, some method and apparatus may be useful for effecting non-contentious use of a resource such as network interface controller 117.

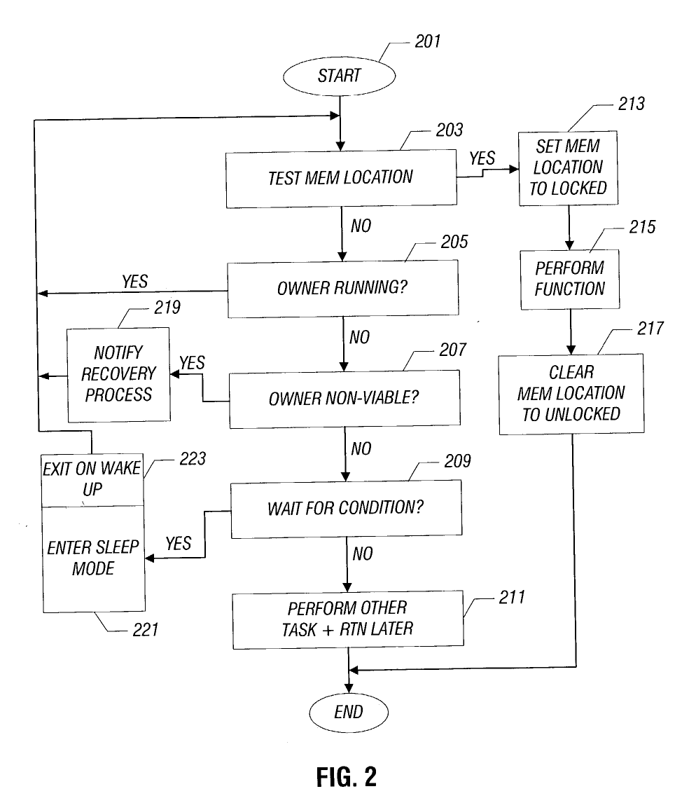

Referring now to FIG. 2, an operation that may be referred to a “set process info” may be as illustrated. The illustrated flow chart may be utilized by a process such as process 1, 129 or process 2, 131, to communicate to another processes a status. The status may, in some embodiments, be related to the utilization of a resource by a process. In some embodiments the communications may be any sort of process information.

A process may start 201 and test a memory location 203. The testing of the memory location may be performed, in some embodiments, to determine whether that memory location is “locked”. “Locked” in this context means that the memory location may have one non-empty set of bit patterns that may indicate that a resource associated with the memory location is being utilized. This may be useful, in some embodiments, to indicate that a particular resource is being utilized and, therefore, may be unavailable for another process to use. A process that “locked” the memory location may be considered the “owner” process.

A memory location is “unlocked” if its value is one of a non-empty set of bit patterns that do not intersect with the bit patterns used to indicate a “locked” status. The union of the bit patterns indicating a locked status and the bit patterns indicating an unlocked status do not have to cover the entire space of possible bit patterns for the memory location.

If the memory location 203 is locked, then a test may be made, in some embodiments, to determine if the owner process is running 205. It may be possible, for a memory location 203 to be locked and the owner process to have ceased running for one or more reasons. For example, the owner process may be in a scheduling queue waiting for a “time slice” or other event. The set of bit patterns indicating a locked status may also be utilized to determine the status of the owner or another process or device.

Should it be determined at 205 that the owner is not running, a test may be performed, in some embodiments, to determine if the owner is nonviable 207. A nonviable owner may be the result of a hardware or software anomaly or other reason whereby the process is no longer executing normally. If it is determined that the owner is viable, the process may, in some embodiments, proceed in at least one of two ways. In the first way, if the process is not waiting for a condition precedent to run, the process may perform other tasks and return later to the loop to determine, for example, if the memory location tested at 203 is now unlocked.

In the second way, if, while testing memory location 203, it is determined that the memory location is unlocked, which is to say the resource may now be available, the process may set the memory location to locked 213 and perform one or more functions 215 with the resource now owned by the process. When the process has finished performing one or mote functions with the resource, the process may then set the memory location to unlocked 217 to indicate to another process that may test the memory location that the resource associated with that memory location is now available for utilization by other processes.

If the owner process is running 205, then the process may loop back and continue to test the memory location 203 until such time as the memory location test indicates that the memory location is now unlocked. This may be an efficient method as, typically, when an owner process is running, the resource that it is utilizing may become available relatively soon.

If, during the test at 207, the owner was determined to be nonviable, that is to say the process has stopped for one or more reasons, the process that has determined the owner to be nonviable may, in some embodiments, notify a recovery process 219 that may serve to clear the memory location that was locked and may take other action such as to restore the nonviable owner process. A process may determine if another process is viable by, in some embodiments, testing a shared memory location that may have a value set by a “watch dog” or other process.

If at 209 a process determined that it must wait for a condition precedent to continue processing, then the process may enter a sleep mode 221 and exit that sleep mode on a wake up call 223 that may be provided by an operating system such as operating system 127. The exit on wake up 223 may occur, in some embodiments, when the operating system 127 determines that, in some embodiments, the resource needed by the process may now be available. Upon the exit on wake up 223, the process may return to test for the memory location being unlocked 203 and proceed as previously described.

The method described in association with FIG. 2 may be particularly effective for situations where a process may have to wait for a particular condition to be satisfied before it can continue to process, in which case it may enter a sleep mode or, if a condition does not need to be satisfied, it may perform other useful tasks and, thereby, reduce the overall latency for the portion of a program that may be associated with the process implementing one or more of the methods described in association with FIG. 2.

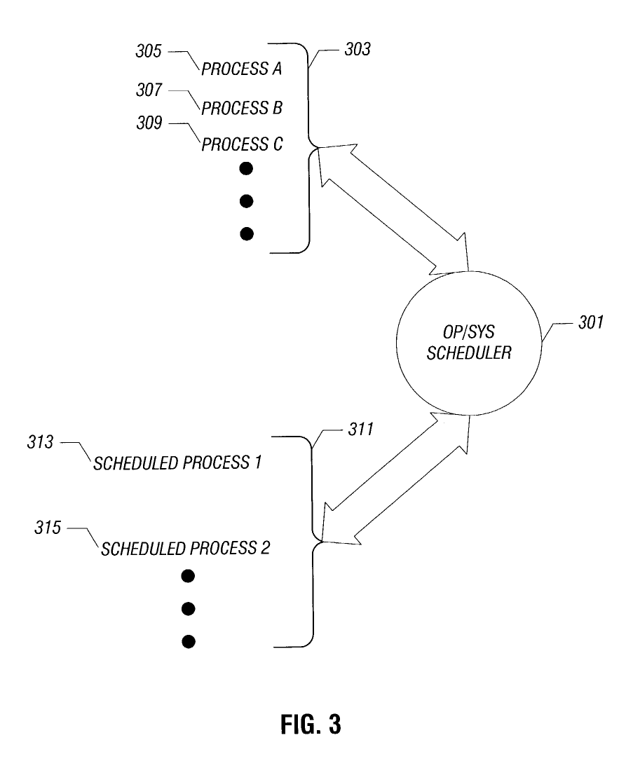

Referring now to FIG. 3, in an operation that may be referred to as a “wait for value” process, an operating system scheduler 301 may take unscheduled processes 303, such as process A, 305, process B, 307, and process C, 309 and add them to the scheduled processes 311 such as scheduled process 313 and 315. One or more of the processes 303 may be scheduled if, for example, all conditions precedent to an unscheduled process running are satisfied. In some embodiments, operating scheduler 301 may determine that a process such as process 305, 307, or 309 is in a sleep mode until a resource is available. Upon the resource being available, the operating system 301 may then wake up one of the processes 305, 307, or 309 and place it in the scheduled process list 311 for execution. The operating system scheduler 301 may also perform many other tests to determine which of many unscheduled processes, such as 303, should be scheduled next.

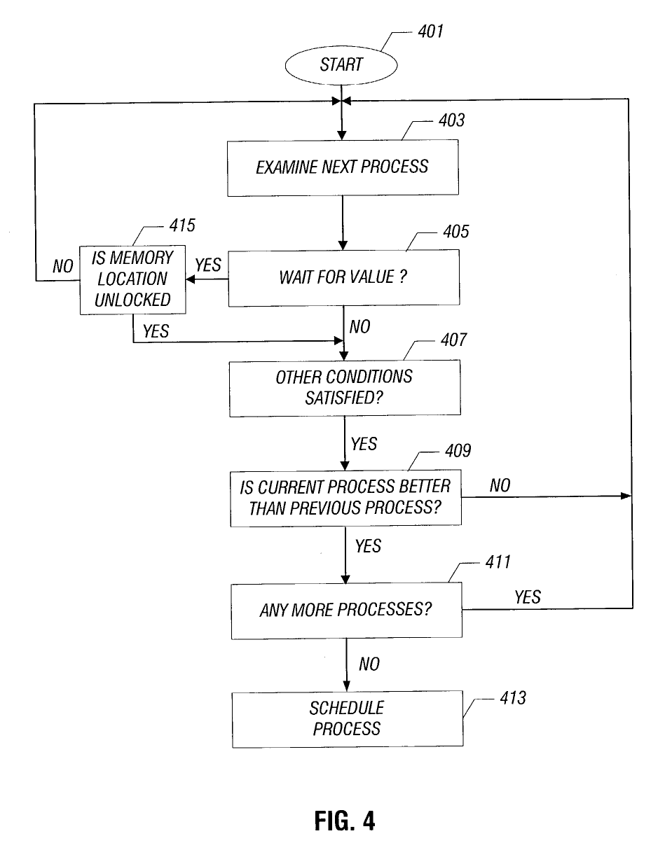

Referring now to FIG. 4, the flow chart illustrated in FIG. 4 may be utilized, in some embodiments, by an operating system scheduler, such as operating system scheduler 301, to schedule unscheduled processes such as processes 303.

The operating system scheduler may start 401 and examine the next process 403 on the unscheduled list 303. The operating system scheduler 301 may determine the next process to examine by any of many algorithms such as first on the list, last on the list, or any other useful algorithm. The operating system scheduler may test whether the process is unscheduled because it is waiting for a value 405. This value may be, for example, a value indicating a memory location is locked or unlocked. If not, then a test may be performed to determine if other conditions arc satisfied for the process to run 407. In some embodiments other tests (not illustrated) may be performed before or after the test at 405.

The operating system scheduler 301 may then, in some embodiments, determine whether the current process is better than a previous process 409 for scheduling. If the current process is the best choice of the processes that have been examined for scheduling, the operating system scheduler may determine if any more processes 411 are available as candidates. If no more processes are available, the operating system scheduler 301 may schedule the current process 413 for execution.

For example, if the operating system scheduler 301 determines that a process is waiting for a value 405 in a memory location, the operating system scheduler may then test to see is the memory location has the necessary value or values 415. The operating system scheduler may cause a memory location to be tested to detect if one of a non-empty set of bit patterns. The bits may indicate that the memory location is unlocked. If the memory location is not unlocked, that is, is not one of the particular bit patterns indicating an unlocked status, then the operating system may select another process 403. If the memory system is unlocked, then the operating system scheduler 301 may then proceed to determine whether other conditions are satisfied 407 for that process to run as previously described. If the process being evaluated by the operating system scheduler 301 is not better than the previous process at the test 409, then the operating system scheduler may return and examine other unscheduled processes 403.

This method may be advantageous for the operating system scheduler 301 to determine when an unscheduled process 303 should be scheduled and add it to the scheduled list 311. Additionally, this process may be utilized, in some embodiments, to determine which of the unscheduled processes 303 should be scheduled as the next process to be executed on the computer system 100.

The method and apparatus described in association with FIGS. 1 through 4, may be utilized to allow one or more processes to communicate the process or other status information, for example, the status that a process may be utilizing a resource. By utilizing a memory location that may be shared between one or more processes, a particular process may quickly determine the status or other information related to another process without having to make one or more operating system calls that may increase program latency or introduce other undesirable effects. Of course, the methods and apparatus described may be utilized to pass data or other status information from one process to another process besides resource utilization information.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a set of, at least one, processors;
an operating system executing on the set of processors;
at least a first and an owner process executing on the set of processors; and
wherein the first process determines without a context switch, at least in part, the status of an owner process and the first process executes instructions based, in part, on the status of the owner process.

2. The apparatus as in claim 1 wherein the status is associated with the owner process utilization of a resource.

3. The apparatus as in claim 1 wherein the first process enters a sleep mode until the operating system can detect that the resource has become available.

4. The apparatus as in claim 3 wherein the first process executes instructions based on the operational status of the owner process.

5. The apparatus as in claim 1 wherein the first process determines the status of the owner without making an operating system call.

6. A method comprising:
determining by a first process a status of an owner process; and
processing tasks by the first process until the resource becomes available and the owner process is viable and not running.

7. The method as in claim 6 further comprising determining by the first process the utilization of a resource.

8. The method as in claim 6 further comprising the first process entering a sleep mode, in part, in response to the determined status of the owner process.

9. The method as in claim 6 further comprising the first process determining the owner's status without performing an operating system call.

10. The method as in claim 9 further comprising the first process executing instructions based, in part, on the status of the owner process.

11. A method comprising:
determining, in part, an availability status of a resource by a first process; and
if the resource is not available, then entering a sleep mode if an owner process is determined to be viable and not running.

12. The method as in claim 11 further comprising the first process determining the availability status of a resource without making an operating system call.

13. The method as in claim 12 further comprising the first process exiting the sleep mode after the memory location contains a predetermined set of one or more values.

14. The method as in claim 13 further comprising the first process reading the memory location a plurality of times until the memory location contains a predetermined set of one or more values and the owner process is determined to be viable and running.

15. The method as in claim 14 further comprising the first process reading the memory location a plurality of times until the memory location contains a predetermined set of one or more values and the owner process is determined to be not viable.

16. An apparatus comprising:
means for determining a status of an owner process in a multi-process computer system, without causing an operating system call to be performed; and
means for causing a first process to execute instructions based, in part, on the operational status of an owner process of the shared resource.

17. The method as in claim 16 further including means for causing the first process to enter a sleep mode, in part, in response to the status of the owner process.

18. The method as in claim 17 further including means for causing the first process to enter a sleep mode, in part, in response to the utilization of a resource by the owner process.

19. The method as in claim 17 further including means for causing the first process to exit the sleep after a memory location contains a set of one or more predetermined values.

20. The method as in claim 16 further including means for the owner process to lock a memory location associated with a resource.
